(19) United States
(12) Patent Application Publication
(10) Pub. No.: US 2018/0232709 A1
(43) Pub. Date: Aug. 16, 2018

(54) WASTE MANAGEMENT APP FOR BULK MATERIAL REMOVAL

(71) Applicant: Rubicon Global Holdings, Inc., Altanta, GA (US)

(72) Inventor: Philip RODONI, Decatur, GA (US)

(73) Assignee: Rubicon Global Holdings, Inc., Altanta, GA (US)

(21) Appl. No.: 15/432,179

(22) Filed: Feb. 14, 2017

(51) Int. Cl. G06Q 10/00; G06Q 20/10; H04N 7/18

(52) U.S. Cl. CPC G06Q 10/30; H04N 7/185; G06Q 20/10

(57) ABSTRACT

A system is provided for use in managing waste services. The system may include a first portal with a first memory, a first processor, and a first display; and a second portal with a second memory, a second processor, and a second display. The system may also include a network connecting the first and second portals. Each of the first and second processors may execute computer-executable instructions to receive information from a consumer associated with desired disposal of a bulk item, and to show on the first and second displays the information. Each of the first and second processors may also execute the computer-executable instructions to receive at least one of an acceptance or an offer from a hauler to provide the desired disposal, to receive electronic payment from the consumer for completion of the desired disposal, and to make electronic payment to the hauler after confirmation of the completion.

### TECHNICAL FIELD

The present disclosure relates generally to an app (i.e., a downloadable self-contained software application) for use on a mobile device. More particularly, the present disclosure relates to a system and method for providing a waste management app that can be used to coordinate bulk material removal services.

### BACKGROUND

Conventional waste service providers typically dispatch specialized vehicles to service consumer properties according to a regular pickup schedule. The service generally includes emptying of the same number of standard size containers. After completion of each waste service, the vehicle operator reports the completion to a back office, which updates an account record for the consumer. Consumers that subscribe to these waste services are then billed based on the account record.

Although conventional waste services may satisfy many consumer needs, there may be times when a particular consumer has a bulk item (e.g., an item too large to fit inside of the standard size container, such as a couch or a refrigerator) or excessive waste (e.g., waste in excess of an allowed limit) that must be disposed of. In these instances, conventional waste service providers may be unable to satisfy the consumer's needs. When this occurs, the consumer must make special arrangements with an independent local contractor for disposal of the item. This can be time consuming, difficult, and expensive.

The disclosed system, method, and app are directed to overcoming one or more of the problems set forth above and/or other problems of the prior art.

### SUMMARY

In one aspect, the present disclosure is directed to a system for managing waste services. The system may include a first portal having a first memory with computer-executable instructions stored thereon, a first processor, and a first display; a second portal having a second memory with computer-executable instructions stored thereon, a second processor, and a second display; and a network connecting the first and second portals. Each of the first and second processors may be configured to execute the associated computer-executable instructions to receive information from a consumer associated with desired disposal of a bulk item, and to show on the first and second displays the information associated with the desired disposal of the bulk item. Each of the first and second processors may also be configured to execute the associated computer-executable instructions to receive at least one of an acceptance or an offer from a hauler to provide the desired disposal, to receive electronic payment from the consumer for completion of the desired disposal, and to make electronic payment to the hauler after confirmation of the completion.

In another aspect, the present disclosure is directed to a computer-implemented method for managing waste services. The method may include receiving information from a consumer associated with desired disposal of a bulk item, and displaying the information associated with the desired disposal of the bulk item. The method may also include receiving at least one of an acceptance or an offer from a hauler to provide the desired disposal, receiving electronic payment from the consumer for completion of the desired disposal, and making electronic payment to the hauler after confirmation of the completion.

In yet another aspect, the present disclosure is directed to a non-transitory computer readable medium containing computer-executable programmable instructions for performing a method for managing waste services. The method may include receiving information from a consumer associated with desired disposal of a bulk item. The information may include a location, a price, at timing, and at least one of a picture and a description. The method may also include displaying the information associated with the desired disposal of the bulk item, and receiving at least one of an acceptance or an offer from a hauler to provide the desired disposal. The method may further include receiving electronic payment from the consumer for completion of the desired disposal, confirming completion of the desired disposal based on at least one of input from the consumer and a picture or a receipt from the hauler, and making electronic payment to the hauler after confirmation of the completion.

### BRIEF DESCRIPTION OF THE DRAWINGS

FIG. 1 is a diagrammatic illustration of an exemplary disclosed waste management system;

FIG. 2 is a diagrammatic illustration of an exemplary disclosed communication portal that may be used in conjunction with the waste management system of FIG. 1; and

FIG. 3 is a flowchart of an exemplary disclosed method that may be implemented by the waste management system of FIG. 1.

### DETAILED DESCRIPTION

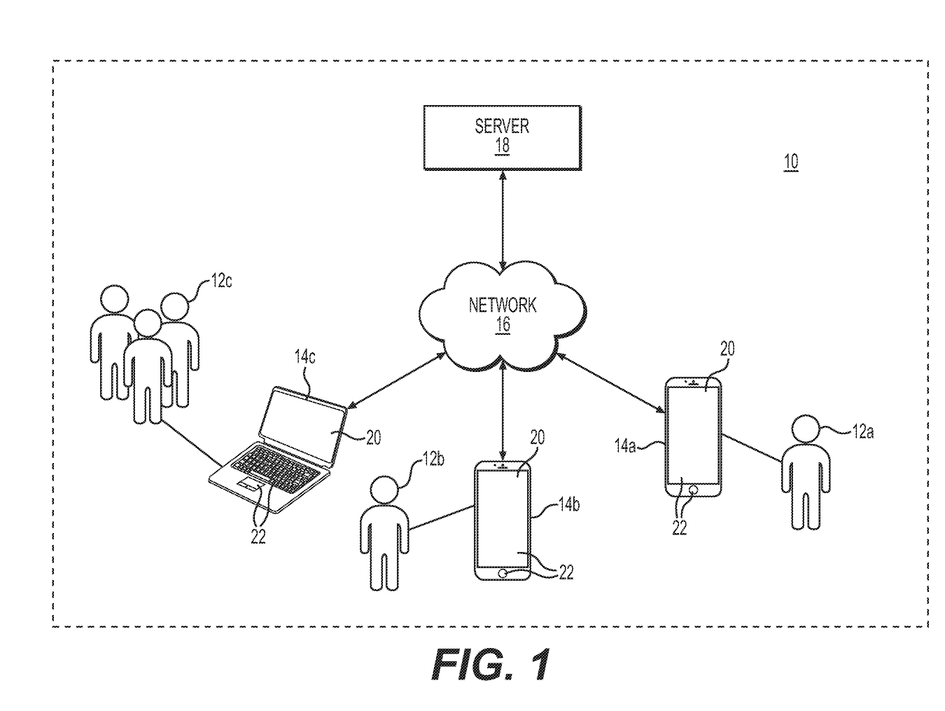

FIG. 1 shows an exemplary waste management system (“system”) 10, in which various implementations described herein may be practiced. System 10 represents, for example, a collaborative environment that allows remotely located participants 12 (e.g., a service consumer 12a, a service provider such as a hauler 12b, and any number of additional consumers or service providers 12c) to engage in real-time commercial interactions via any number of separate communication portals 14 (e.g., a first portal 14a, a second portal 14b, and a third portal 14c). Communication portals 14 may be connected to each other, for example, by way of a network 16 and a server 18. It is also contemplated that communication portals 14 could alternatively be connected to each other by way of a peer-to-peer connection, if available.

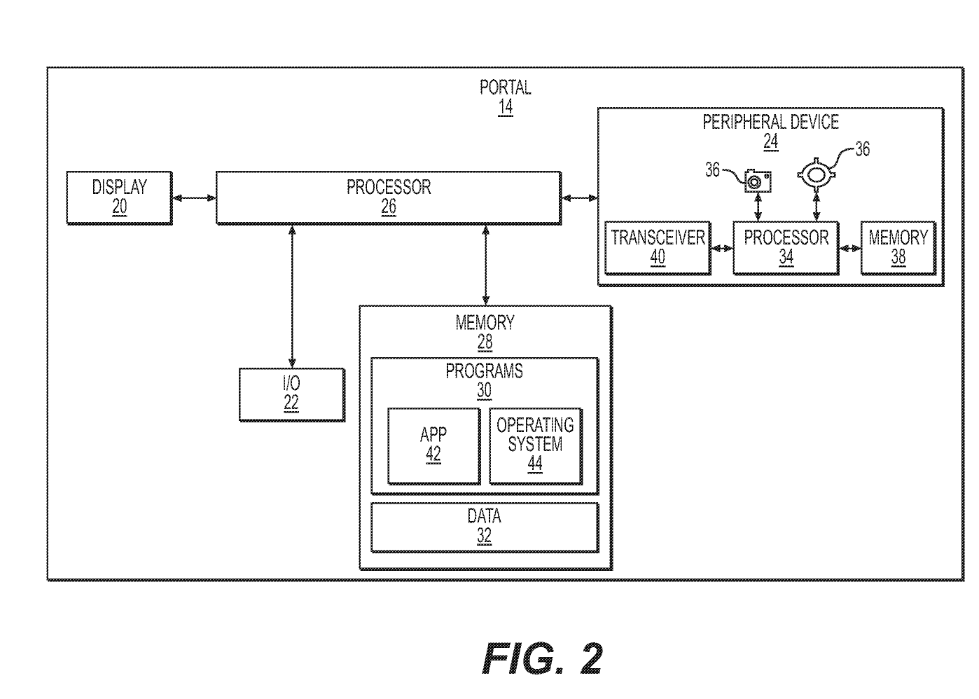

Each portal 14 may be an electronic device having data entry, data transmission, and/or data display capabilities. In some embodiments, one or more of portals 14 are mobile computing devices such as a smart phone, a tablet, a Personal Digital Assistant (PDAs), a laptop or notebook computer, or any combination of these devices. In other embodiments, one or more of portals 14 is a stationary device such as a desktop computer. As shown in the exemplary component diagram of FIG. 2, portal 14 may include a display 20, any number of input/output (“I/O”) devices 22, one or more peripheral devices 24, one or more single- or multi-core processors 26, and a memory 28 having stored thereon one or more programs 30 and data 32.

Display 20 may include a liquid crystal display (LCD), a light emitting diode (LED) screen, an organic light emitting diode (OLED) screen, and/or another known display device. Display 20 may be used for the rendering of video signals, graphics, and text under the control of processor 26.

I/O devices 22 may be configured to send and receive information. I/O devices 22 may include, for example, a keyboard, buttons, switches, a touchscreen panel (e.g., a panel integrated with display 20), a microphone, and/or a speaker (e.g., a speaker integrated with display 20). I/O devices 22 may also include one or more communication modules (not shown) for sending information to and receiving information from other components of system 10 by, for example, establishing wired or wireless connectivity between portals 14 and network 16 (referring to FIG. 1).

Peripheral device(s) 24 may be standalone devices or devices that are embedded within portal 14. As shown in the example embodiment of FIG. 2, peripheral devices 24 can themselves also include one or more processors 34, as well as one or more sensors (e.g., a camera, a GPS receiver, a microphone, etc.) 36, a memory 38, and a transceiver 40. It is contemplated that peripheral device 24 can include additional or fewer components (e.g., depending on the type of portal 14).

Processor 34 of peripheral device 24 may be configured with virtual processing technologies, and use logic to simultaneously execute and control any number of operations. Processor 34 may be configured to implement virtual machine or other known technologies to execute, control, run, manipulate, and store any number of software modules, applications, programs, etc. In some embodiments, processor 34 can be configured to execute instructions to receive commands from processor 26 associated with video, audio, and/or location data capture and/or transmission. It is contemplated that, in some embodiments, processor 34 may be omitted and the functions described above alternatively performed directly by processor 26, if desired.

Memory 38 can be a volatile or non-volatile, magnetic, semiconductor, tape, optical, removable, non-removable, or other type of storage device or tangible (i.e., non-transitory) computer-readable medium that stores computer executable code such as firmware that causes processor 34 to perform one or more functions associated with data capture, data processing, data storage, data transmitting via transceiver 40, and data receiving via transceiver 40. In some embodiments, memory 38 can include one or more buffers for temporarily storing data received from sensor(s) 36, before transmitting the data to processor 26.

Transceiver 40 may include a wired or wireless communication module capable of sending and receiving data via network 16, a local network, and/or another direct communication link with one or more components in system 10. In some embodiments, transceiver 40 can receive data from processor 26, including instructions for processor 34 to activate sensor(s) 36 and capture video/audio/location (e.g., GPS) data and for processor 34 to transmit the data via transceiver 40. In response to the received instructions, transceiver 40 can packetize and transmit the video/audio/location data to processor 26 and/or directly to network 16.

Processor 26 can include one or more processing devices configured to perform functions of the disclosed methods. Processor 26 can constitute a single core or multiple core processors executing parallel processes simultaneously. For example, processor 26 can be a single core processor configured with virtual processing technologies. In certain embodiments, processor 26 uses logical processors to simultaneously execute and control multiple processes. Processor 26 can implement virtual machine technologies, or other known technologies to provide the ability to execute, control, run, manipulate, store, etc. multiple software processes, applications, programs, etc. In another embodiment, processor 26 includes a multiple-core processor arrangement (e.g., dual, quad core, etc.) configured to provide parallel processing functionalities to allow portal 14 to execute multiple processes simultaneously. As discussed in further detail below, processor 26 is specially configured with one or more applications and/or algorithms for performing method steps and functions of the disclosed embodiments. For example, processor 26 (and portal 14) can be configured with hardware and/or software components that enable processor 26 to receive real-time sensor feed, record video, record audio, record location, receive control instructions regarding desired waste services, and selectively transmit to other connected portals 14 the recorded information and control instructions. It is appreciated that other types of processor arrangements could be implemented that provide for the capabilities disclosed herein.

Memory 28 may include a volatile or non-volatile, magnetic, semiconductor, tape, optical, removable, non-removable, or other type of storage device or tangible and/or non-transitory computer-readable medium that stores one or more executable programs 30, such as a waste management app 42 and data 32. Data 32 can include, for example, information that is personal to the operator of portal 14, account information, settings, and preferences.

In some embodiments, programs 30 also includes an operating system 44 that performs known functions when executed by processor 26. By way of example, the operating system may include Microsoft Windows™, Unix™, Linux™, Apple™ operating systems, Personal Digital Assistant (PDA) type operating systems, such as Microsoft CE™, or another type of operating system. Portal 14 may also include communication software that, when executed by processor 26, provides communications with network 16 (referring to FIG. 1), such as Web browser software, tablet, or smart hand held device networking software, etc.

Waste management app 42 may cause portal 14 to perform processes related to generating, transmitting, storing, and receiving data in association with other participants of a waste service commercial agreement. For example, waste management app 42 may be able to configure portal 14 to perform operations including: displaying a graphical user interface (GUI) for receiving disposal instructions and related information from the operator of portal 14 (from a consumer 12a); capturing photographic and/or video data associated with a bulk item requiring disposal; capturing location data associated with the bulk item; receiving instructions via I/O devices 22 and/or the user interface regarding timing and/or cost for disposal of the bulk item; processing the control instructions; sending the video data, the location data, and the instructions to another portal 14 (to portal 14b of a hauler 12b via network 16 and server 18 or directly); receiving data and instructions from other portals 14; and arranging for electronic payment in association with confirmed disposal of the bulk item.

Network 16 may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components. For example, the communication links may include non-proprietary links and protocols, or proprietary links and protocols based on known industry standards, such as J1939, RS-232, RP122, RS-422, RS-485, MODBUS, CAN, SAEJ1587, Bluetooth, the Internet, an intranet, 802.11 (b, g, n, ac, or ad), or any other communication links and/or protocols known in the art.

Server 18 may be a single server or a distributed system of multiple servers that cooperate to perform one or more of the processes and functionalities associated with the disclosed embodiments. For example, server 18 can include one or more desktop computers, workstations, handheld computing devices (smart phones or tablets), memory devices, and/or internal networks. As will be described in more detail below, server 18 may be configured to manage access between different portals 14 and/or other resources on network 16.

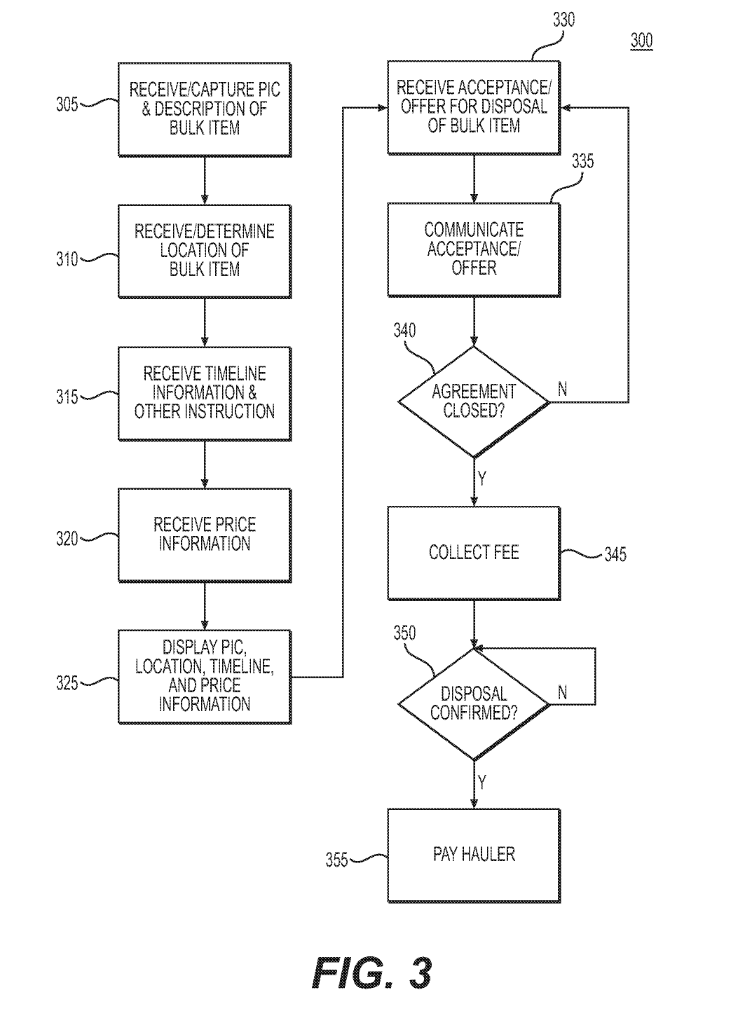

FIG. 3 illustrates a flowchart of an exemplary method 300 for managing a waste service. Method 300 can be performed by the various devices disclosed above. For example, in some embodiments, method 300 is performed by each of portals 14 and/or server 18. Method 300 will be explained in more detail below to further illustrate the disclosed concepts.

### INDUSTRIAL APPLICABILITY

The disclosed system may be applicable to the waste service industry. In particular, the disclosed system, method, and app may provide a way for individual consumers of waste services to arrange with independent and/or crowd-sourced service providers (haulers) for intermittent (e.g., one-time) disposal of bulk items (e.g., items and/or quantities not normally disposed of on a regular basis inside of standard size containers via a subscription service). For example, the disclosed system, method, and app may provide a way for a consumer to upload an image or video, a location, information (e.g., photo, description, location, etc.), and associated instructions regarding desired disposal of a particular bulk item (e.g., a couch or a refrigerator). The disclosed system, method, and app may also provide a way for a hauler to contract directly with the consumer for disposal of the bulk item. The disclosed system, method, and app may additionally provide a way for completion of the disposal service to be confirmed and for electronic payment for the completed service to be made. Operation of the disclosed system will now be described, with reference to FIG. 3.

Method 300 may be initiated by a consumer whenever the consumer has a need for disposal of a bulk item. In particular, in response to input from the consumer and under the direction of processor 26 of the corresponding portal 14 (e.g., portal 14a), a graphical user interface (GUI) associated with the disclosed app may be brought to the foreground of portal 14a. Via the GUI, portal 14a may receive (e.g., via upload) and/or capture a picture of the bulk item (step 305). In some instances, a description of the bulk item may also be received via portal 14a (e.g., via I/O devices 22). The description may include, for example, a size of the item, a weight of the item, a condition of the item, etc.

Portal 14a may then receive and/or determine a location of the bulk item (step 310). For example, in response to consumer input indicative of a desire for the bulk item to be disposed of, peripheral device 24 may be selectively activated to detect a current location of portal 14a that is assumed to have the same general location as the bulk item. Alternatively, the consumer may manually indicate the location of the bulk item (e.g., manually type in an address at which the bulk item is located) via I/O devices 22.

Portal 14a may also receive from the consumer (e.g., via I/O devices 22) a timeline and/or other instructions regarding disposal of the bulk item (step 315). For example, the consumer may be able to indicate a particular date, day of the week, time, and/or time window when the bulk item will be set out for retrieval (e.g., on Friday the 13^{th}, within the next three days, between 8 and 10 pm, etc.). In addition, the consumer may be able to specify how to gain access to the bulk item (e.g., by providing a gate code), provide direction of how to reach the location, instruct how the bulk item will be stored (e.g., under a blue tarp), or direct how the bulk item should be disposed of (e.g., dumped at the landfill, recycled, taken to a local charity, etc.). In some embodiments, the consumer may also be able to select filtering operations associated with potential haulers. For example, the consumer may be able to indicate (e.g., via I/O devices 22) that the disposal service should be performed only by a hauler having a particular approval rating (e.g., four stars or greater) and/or a particular certification (e.g., approval to handle/disposed of biological waste, chemical waste, nuclear waste, etc.).

In some instances, portal 14a may also receive price information from the consumer (step 320). That is, the consumer may be able to specify how much the consumer is willing to pay for disposal of the bulk item. In other instances, the price information may not be provided and the consumer may thereby invite bids for completion of the disposal service.

It should be noted that steps 305-320, although described in a particular order for exemplary purposes, may be completed in any desired order. After completion of steps 305-320, that disclosed app may allow for the picture, location, timeline, and price information to be shown on displays 20 of other portals 14 (e.g., portal 14b—step 325). It is contemplated that this display of information may be generated only in response to a potential hauler requesting the information (e.g., when the potential hauler logs into a job board feature of the disclosed app), or that the display may be automatically shown to all potential haulers meeting a particular criteria (e.g., a geographical criteria, an availability criteria, a capability criteria, a price criteria, an approval rating criteria, etc.). Information shown in the job board feature described above may be stored within a memory of server 18 and/or in a separate database (not shown). Additionally or alternatively, the information shown in the job board feature of the disclosed app may be communicated to and stored (e.g., within a library that is indexed based on a region, a date, a consumer, a hauler, a timeline, etc.) within the memories of the other portals 14b, for example via network 16.

Any potential hauler (e.g., a previous consumer, a dedicated hauler, or a general member of the public) may utilize portal 14b to accept and/or provide an offer for disposal services. For example, after viewing a listing of disposal jobs (e.g., via the job board feature of the disclosed app), a particular hauler may accept a particular job as offered by the consumer, or instead offer to provide the requested service under modified terms (e.g., for a different price, at a different time, in a different manner, etc.). Portal 14b may receive the acceptance/offer (step 330), and communicate the acceptance/offer to the corresponding consumer (e.g., to portal 14a via network 16 and/or server 18—step 335). The consumer may then have the option to close the agreement (e.g., to form a contract, to accept or reject the offer, etc.).

Processor 26 (and/or server 18), via the disclosed app, may then determine when the agreement has been closed (step 340), and then electronically collect the agreed-upon fee from the consumer (step 345). This fee may not be immediately passed onto the contracted hauler, but instead held in escrow until after completion of the agreed-upon service has been confirmed. Processor 26 (and/or server 18), via the disclosed app, may determine that the disposal service has been completed (step 350) in any number of different ways. For example, the consumer may provide an indication that the service was completed; and/or the hauler may provide proof (e.g., pictures, disposal receipts, GPS history information, etc.) that the service was completed. Portal 14a and/or 14b may receive this indication and/or proof, and then cause the previously collected fee to be electronically passed on to the hauler (step 355).

The disclosed system, method, and app may provide many benefits. For example, any consumer may be able to receive on-demand disposal services of bulk items in a manner (e.g., time, location, price, etc.) desired by the consumer. In addition, employment opportunities may be provided to the local community, as anyone can be a potential hauler. Further, the simplicity and low-cost nature of the disclosed system, method, and app may encourage proper disposal of waste items, thereby encouraging a greener environment.

In the preceding description, various preferred embodiments have been described with reference to the accompanying drawings. It will, however, be evident that various modifications and changes may be made thereto, and additional embodiments may be implemented, without departing from the broader scope of the disclosure. The disclosure and drawings are accordingly to be regarded in an illustrative rather than restrictive sense. For example, advantageous results still could be achieved if steps of the disclosed techniques are performed in a different order or if components in the disclosed system were combined in a different manner or replaced or supplemented by other components. Therefore, it is intended that the disclosed embodiments and examples be considered as examples only.

What is claimed is:

1. A system for managing waste services, comprising:
a first portal having a first memory with computer-executable instructions stored thereon, a first processor, and a first display;
a second portal having a second memory with computer-executable instructions stored thereon, a second processor, and a second display; and
a network connecting the first and second portals,
wherein each of the first and second processors is configured to execute the associated computer-executable instructions to:
receive information from a consumer associated with desired disposal of a bulk item;
show on the first and second displays the information associated with the desired disposal of the bulk item;
receive at least one of an acceptance or an offer from a hauler to provide the desired disposal;
receive electronic payment from the consumer for completion of the desired disposal; and
make electronic payment to the hauler after confirmation of the completion.

2. The system of claim 1, wherein the information includes at least one of a picture and a description of the bulk item.

3. The system of claim 2, wherein at least one of the first and second portals includes:
a peripheral device configured to take the picture of the bulk item; and
an input/output device configured to receive the description of the bulk item.

4. The system of claim 2, wherein the information further includes a price that the consumer is willing to pay for the desired disposal of the bulk item.

5. The system of claim 2, wherein the information further includes a timing of the desired disposal.

6. The system of claim 2, wherein the information further includes a manner in which the desired disposal is to occur.

7. The system of claim 1, wherein each of the first and second processors is configured to execute the associated computer-executable instructions to confirm completion of the desired disposal based on input from the consumer.

8. The system of claim 1, wherein each of the first and second processors is configured to execute the associated computer-executable instructions to confirm completion of the desired disposal based on proof from the hauler.

9. The system of claim 8, wherein the proof includes at least one of a picture and a disposal receipt.

10. The system of claim 1, wherein at least one of the first and second processors is configured to execute the associated computer-executable instructions to:
determine a location of the bulk item; and
show on at least one of the first and second displays the location of the bulk item in association with the information.

11. The system of claim 10, wherein each of the first and second portals includes at least one peripheral device configured to provide the location of the bulk item to the first and second processors.

12. A computer-implemented method for managing waste services, comprising:
receiving information from a consumer associated with desired disposal of a bulk item;
displaying the information associated with the desired disposal of the bulk item;
receiving at least one of an acceptance or an offer from a hauler to provide the desired disposal;
receiving electronic payment from the consumer for completion of the desired disposal; and
making electronic payment to the hauler after confirmation of the completion.

13. The computer-implemented method of claim 12, wherein the information includes at least one of a picture and a description of the bulk item.

14. The computer-implemented method of claim 13, wherein the information further includes a price that the consumer is willing to pay for the desired disposal of the bulk item.

15. The computer-implemented method of claim 13, wherein the information further includes a timing of the desired disposal.

16. The computer-implemented method of claim 13, wherein the information further includes a manner in which the desired disposal is to occur.

17. The computer-implemented method of claim 12, further including confirming completion of the desired disposal based on input from the consumer.

18. The computer-implemented method of claim 12, further including confirming completion of the desired disposal based on proof from the hauler.

19. The computer-implemented method of claim 18, wherein the proof includes at least one of a picture and a disposal receipt.

20. The computer-implemented method of claim 12, further including:
determining a location of the bulk item; and
displaying the location in association with the information.

21. A non-transitory computer-readable medium encoded with instructions, which when executed by a processor, cause the processor to perform a method for managing waste services, comprising:
receiving information from a consumer associated with desired disposal of a bulk item, the information including a location, a price, at timing, and at least one of a picture and a description;
displaying the information associated with the desired disposal of the bulk item;
receiving at least one of an acceptance or an offer from a hauler to provide the desired disposal;
receiving electronic payment from the consumer for completion of the desired disposal;
confirming completion of the desired disposal based on at least one of input from the consumer and a picture or a receipt from the hauler; and
making electronic payment to the hauler after confirmation of the completion.
